(19) United States
(12) Patent Application Publication
(10) Pub. No.: US 2006/0085323 A1
(43) Pub. Date: Apr. 20, 2006

(54) System and method for analyzing risk within a supply chain

(75) Inventors: Richard Matty, Santa Cruz, CA (US); Anne-Sophie Seigneurbieux, San Jose, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology Inc.

(21) Appl. No.: 10/965,622

(22) Filed: Oct. 14, 2004

(51) Int. Cl. G06Q 40/00

(52) U.S. Cl. 705/38

(57) ABSTRACT

A system and method is provided for identification, quantification, and analysis of risks within a supply chain infrastructure. A combination of risk event data, risk interaction definition, and risk assignment hierarchy is used to dynamically model the expected impact of risk to pre-defined performance measures within the system. The dynamic modeling is carried out with the help of the Monte Carlo simulation engine.

### BACKGROUND OF THE INVENTION

1. Field of Invention

The present invention relates, in general, to the field of systems. More specifically, the embodiments of the present invention relate to systems and methods for analyzing risks within a supply chain system.

2. Description of the Background Art

Supply chain systems often undergo several improvement efforts. These efforts are largely aimed at making informed decisions regarding various factors involved in a supply chain system. These decisions are normally based on a range of statistical data collected through numerous sources within the supply chain system. The collected data is analyzed by using simulation tools. These tools aid in determining and managing the risks associated with the supply chain. Most of these risk simulation tools are software program tools that work with Excel® spreadsheets, which store data about the cost or the time involved in a supply chain system. It is possible that several risk events affect costs involved in a supply chain. For instance, risk events can impact the time or costs involved in a supply chain and are known as time-related or cost-related risks respectively. For example, the costs involved in a supply chain may comprise freight cost, insurance cost, and the like. Simulating risk events by using this information related to costs, or any other information, provides a user with different scenarios for a particular risk event to occur. Thus, the user is presented with a range of possible outcomes.

Monte Carlo simulation is a common technique used by software program tools for risk simulation. Monte Carlo simulation is a kind of simulation that repeatedly generates random values for uncertain variables so as to simulate a model. Uncertain variables are the ones that are not fixed and have a range of possible values. A simulation provides possible outcomes of a model by repeatedly sampling values by using the probability distributions for the uncertain variables. These outcomes, presented in user-friendly formats such as graphs or charts, assist the executive management in making decisions regarding risk management.

However, in the current simulation software packages, risk events are static and not flexible or scalable. Additionally, the risk events are considered independent of the various physical levels, such as region, country, etc., existing in a supply chain. Simulation software users do not have the flexibility to assign a particular risk event at one or more physical levels of the supply chain. As a result, it may not be possible for a simulation software tool to adequately model risks within the supply chain. Also, it is possible for various risk events to be related to each other. This may happen in a situation where a risk event or an impact thereof is dependent on the occurrence of another risk event. Thus, it may not be possible for the simulation software user to derive a correct overview of the impact of all the risk events associated with a supply chain.

### SUMMARY OF EMBODIMENTS OF THE INVENTION

Embodiments of the present invention provide a method of determining risk within a defined system. The method comprises the following steps: (i) identifying at least one performance measure for identifying and quantifying risk events within the defined system; (ii) identifying the risk events that impact the performance measures based on a hierarchy of the defined system; (iii) determining at least one relationship between the identified risk events and the performance measures; (iv) retrieving at least one risk event related to the performance measure associated with the hierarchy of the defined system; (v) quantifying the risk events assigned to the hierarchy of the defined system; (vi) conducting a risk simulation from the quantified risk events assigned to the hierarchy of the defined system to produce at least one simulation output; and (vii) interpreting the simulation output for determining the risk within the defined system.

Embodiments of the present invention provide a system for determining risk within a defined system. The system comprises (i) a performance measure identifier for identifying at least one performance measure for identifying and quantifying risk events within the defined system; (ii) a risk event identifier for identifying risk events that impact the performance measures based on a hierarchy of the defined system; (iii) means for determining at least one relationship between the identified risk events and at least one performance; (iv) a retriever for retrieving at least one risk event related to the performance measure associated with the hierarchy of the defined system; and (v) a simulator for conducting a risk simulation from the quantified risk events that are assigned to the infrastructure of the defined system to produce at least one simulation output for interpretation to determine the risk within the defined system.

These provisions, together with the various ancillary provisions and features which will become apparent to artisans possessing skill in the art as the following description proceeds, are attained by devices, assemblies, systems, and methods of embodiments of the present invention, various embodiments thereof being shown with reference to the accompanying drawings, by way of example only, wherein:

### BRIEF DESCRIPTION OF THE DRAWINGS

FIG. 1 is a schematic diagram illustrating an exemplary system environment for operation of the method, in accordance with various embodiments of the invention.

FIG. 2 is a flow chart illustrating the method in accordance with various embodiments of the invention.

FIG. 3 is a schematic diagram illustrating an exemplary set of tables used by various embodiments of the invention.

FIG. 4 is a schematic diagram illustrating influence interaction between various risk events that have an impact on a performance measure, in accordance with various embodiments of the invention.

FIG. 5 is a schematic diagram illustrating a normal distribution curve for determining impact on a performance measure, in accordance with various embodiments of the invention.

FIG. 6 is a schematic diagram illustrating a beta distribution curve for determining impact on a performance measure, in accordance with various embodiments of the invention.

FIG. 7 is a schematic diagram illustrating an exponential distribution curve for determining impact on a performance measure, in accordance with various embodiments of the invention.

FIG. 8 is a schematic diagram illustrating a lognormal distribution curve for determining the impact on a performance measure, in accordance with various embodiments of the invention.

FIG. 9 is a schematic diagram illustrating a triangular distribution curve for determining the impact on a performance measure, in accordance with various embodiments of the invention.

FIG. 10 is a schematic diagram illustrating a uniform distribution curve for determining impact on a performance measure, in accordance with various embodiments of the invention.

FIG. 11 illustrates an exemplary graphical user interface for inputting information required for simulating the supply chain risks, in accordance with various embodiments of the invention.

FIG. 12 is a schematic diagram illustrating system elements for use by the invention, in accordance with various embodiments of the invention.

FIG. 13 is a flowchart illustrating an exemplary method of operating a risk simulation engine, in accordance with various embodiments of the invention.

FIG. 14 is a flowchart illustrating the function called in FIG. 13 for performing simulation of risk events, in accordance with various embodiments of the invention.

FIG. 15 illustrates exemplary visual representations of simulation outputs, in accordance with various embodiments of the invention.

### DETAILED DESCRIPTION OF EMBODIMENTS OF THE INVENTION

A defined system, according to an embodiment of the invention, can be a supply chain. A supply chain comprises a chain of progression of material and/or information through a process in an organization. It is possible that a large number of risks are involved in a supply chain system. Risk means a possibility of occurrence of an event arising due to the uncertainty of a situation. Risks that impact the supply chain can be called supply chain risks or supply chain risk events. Supply chain risks can be classified into two broad categories: architecture-related risks and product-specific risks. Architecture-related risks are those assigned directly to the physical assets of the supply chain. Architecture-related risks are independent of the type of product being manufactured or transported.

In an embodiment, logical groupings are created to specify the location of the risks within a supply chain. Specific assets are assigned to these logical groupings. For instance, in one embodiment, a logical group may comprise physical assets such as region, country, site, function, and node. A node can be defined as a unique combination of a site and a specific function resulting in an entity that performs one specific function in the supply chain. For instance, if the function of assembling printed circuit boards (PCBs) is being performed at a contract manufacturing site, then the supply chain node is the combination of the specific contract manufacturing site and the function PCB assembly.

The present invention provides a framework for assigning risks in a hierarchical manner at appropriate levels within a defined system such as the supply chain. The risk events can interact with each other directly or indirectly. These risk event interactions are standardized and defined in a manner that supply chain risks can be assigned, modeled, and quantified within the supply chain.

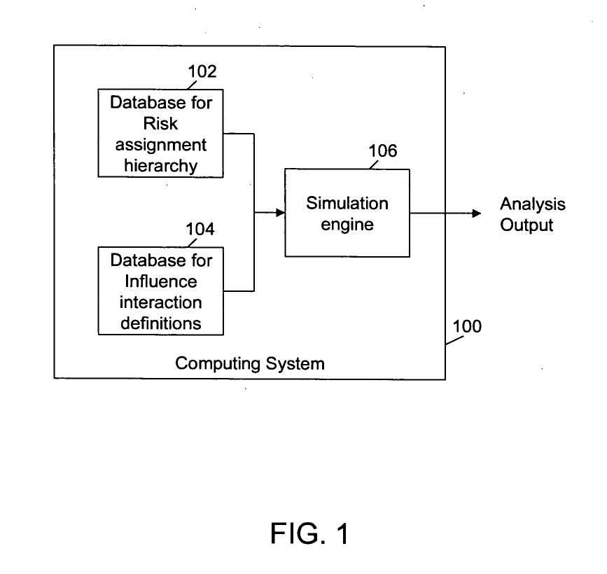

Referring now to FIG. 1, an exemplary computing system 100 is illustrated that can conduct or operate one or more procedures in accordance with various embodiments of the present invention. While other alternatives may be utilized, it is presumed for clarity sake that components of the systems of FIG. 1 and elsewhere, herein, are implemented in hardware, software, or some combination by one or more computing systems consistent therewith, unless otherwise indicated.

Computing system 100 comprises three main components: a database 102 of risk assignment hierarchy, a database 104 of influence-interaction definitions, and a simulation engine 106. Simulation engine 106 combines information in databases 102 and 104 to yield information for risk analysis.

Database 102 of risk assignment hierarchy provides a flexible structure to assign risk events at many physical levels within a defined system such as the supply chain. The structure provided by database 102 facilitates assigning identity tags to various elements contained by a plurality of physical levels within the supply chain system. These identity tags point toward tables containing detailed information relating to these elements. Simulation engine 106 is coded to recognize these assignments for facilitating simulation of the risk events.

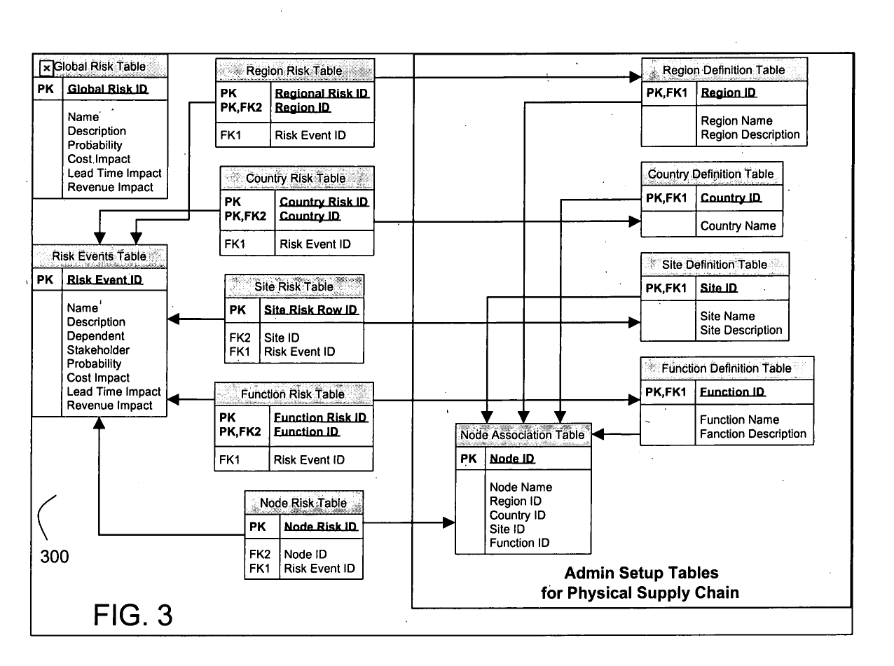

Database 104 of influence-interaction definitions includes data compiled after standardized identification of the risk events and how these risk events influence and interact with each other. In an embodiment of the invention, the risk events that impact a specific performance measure are stored in database 104 in the form of a risk table. Each entry in the risk table corresponds to a specific risk event. In an embodiment of the invention, the data describing influence-interaction definitions is in the form of a chart illustrating the relationships between the various risk events. An exemplary chart that depicts the relationships between the risk events has been illustrated in FIG. 3, and is explained in detail subsequently.

Simulation engine 106 is coded to recognize the interactions or combinations among the risk events. Simulation engine 106 uses the information about risk event interactions to decompose each risk event into their appropriate probabilities of occurrence and their impacts for the purpose of performing random event simulation. In an embodiment, simulation engine 106 is a Microsoft (MS) Excel-based program coded in visual basic to simulate random risk events in the supply chain. Simulation engine 106 uses the information coded for risk assignment hierarchy and influence-interaction definitions to create the appropriate interaction and risk assignments. Thus, a combination of database 102 of risk assignment hierarchy, database 104 of influence-interaction definitions, and simulation engine 106 provides a system and method to quantify and analyze risks within the supply chain.

When implemented in software (e.g. as an application program, object, agent, downloadable servlet, and so on in whole or part), the components of computing system 100 can be communicated transitionally or more persistently from local or remote storage to memory (SRAM, cache memory, etc.) for execution, or another suitable mechanism can be utilized, and elements can be implemented in a compiled or interpretive form. Input, intermediate or resulting data or functional elements can further reside transitionally or persistently in a storage media, cache or other volatile or non-volatile memory, (e.g., storage device or memory) in accordance with a particular application.

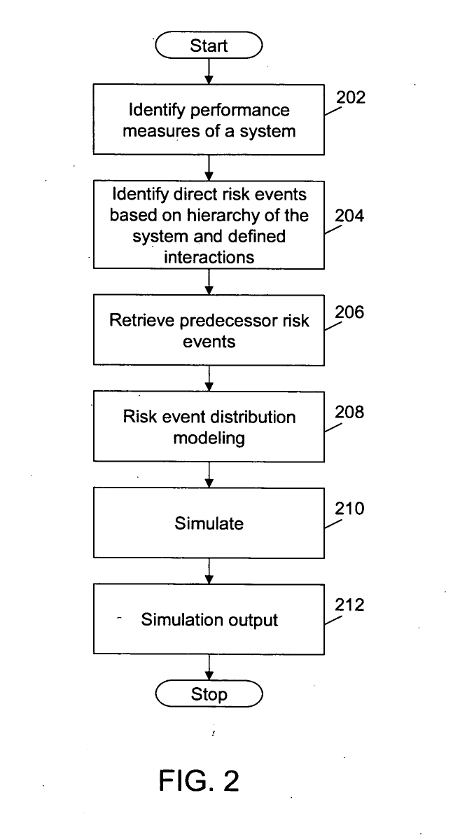

FIG. 2 is a flow chart illustrating the method in accordance with various embodiments of the invention. At step 202, performance measures of the supply chain system are identified. The supply chain can be divided into a hierarchy, consisting of multiple physical levels. Risk events that impact the performance measures are identified at step 204. The invention identifies the direct risk events at step 204 on the basis of the hierarchy of the supply chain and the defined interactions between the risk events that affect the supply chain. The interactions between the identified risk events are determined in the form of risk influence interaction definitions. At step 206, predecessor risk events to the identified risk events are retrieved. Thus, at step 206, any dependencies of the identified risk events in the hierarchy of the supply chain are also considered. Following the retrieval of predecessor risk events, the distribution of various risk events is modeled at step 208. For the purpose of performing the modeling, an embodiment of the invention supports advanced quantification, which takes into account the influence-interaction between the various risk events. At step 210, risk events are simulated to produce at least one simulation result. An embodiment according to the present invention performs Monte Carlo simulation while considering the risk influence-interaction definitions and the assignment of the various risk events to the hierarchy of the supply chain. The simulation output is provided to the user for interpretation at step 212. The simulation output is provided in the form of a visual representation such as a graph, which is used to analyze the expected impact of the risk events or the probability of their occurrence.

A performance measure, identified at step 202, can be a factor in the supply chain that is affected as a result of the occurrence of one or more risk events. A performance measure can be cost-related, time-related, or related to any other important variable within the supply chain. For example, lead time is a time-related performance measure that can be defined as the period of time between the initiation of the supply chain and its completion. Another example is product cost, which is a cost-related performance measure and can be defined as the total cost incurred during the manufacturing or obtaining of a product in the supply chain. The performance measures identified at step 202 help in determining the unit of risk events associated with a specific performance measure. The unit of a risk event is identical to the unit of the performance measure, which is being affected by the risk event. The determined units of risk events, in turn, enable quantification of the risk events.

Following the identification of performance measures, various risk events are identified at step 204. These risk events may bring either positive or negative variations in the corresponding performance measures. Moreover, the identified risk events are based on the hierarchy of the supply chain. The invention provides flexibility to the user by facilitating the assignment of risk events to different elements at all physical levels within the supply chain system. As mentioned earlier, the supply chain hierarchy consists of various physical levels of the supply chain. For instance, the user can assign risk events to elements for a region, a country, a site, a function, or a node. This approach minimizes the number of risk events needed to define an event that applies to multiple nodes or geographic locations. According to an embodiment of the invention, the risk events are associated with the hierarchy of the supply chain system with the help of database 102 of risk assignment hierarchy of the system. New risk events are entered in database 102 by associating them with the appropriate physical levels. Risk events that have been identified at least once previously can be associated with the appropriate physical levels by using the information stored in database 102. The information relating to risk assignment hierarchy is then provided to simulation engine 106, which creates unique identity tags for each geographical or functional location with which a risk event can be associated. Associating risk events by using the identity tags, simplifies the maintenance of risk assignment data in database 102. Each identity tag points to a table created by simulation engine 106. The risk table indicates details regarding the risk events related to the geographical or functional locations within the supply chain. A user can access these risk tables to update, add, or delete the desired information. FIG. 3 illustrates an exemplary set of tables that can be used by an embodiment of the present invention. In an embodiment of the invention, Oracle® may be used as the back-end database for supporting the transition of risk analysis and simulation to the web.

The events identified at this step are risks that have a direct or indirect impact on one or more performance measures associated with the supply chain. The risk events that have a direct impact on a performance measure may be independent of any other risk event or may be dependent on the occurrence of one or more predecessor risk events. The predecessor risk events affect a performance measure indirectly. Thus, they are also called as indirect risk events. Indirect risk events influence direct risk events or the impact of the direct risk events so as to affect a performance measure. Further, it is possible that one or more risk events influence one or more of the remaining risk events. Possible interactions existing between the various risk events are determined at step 206.

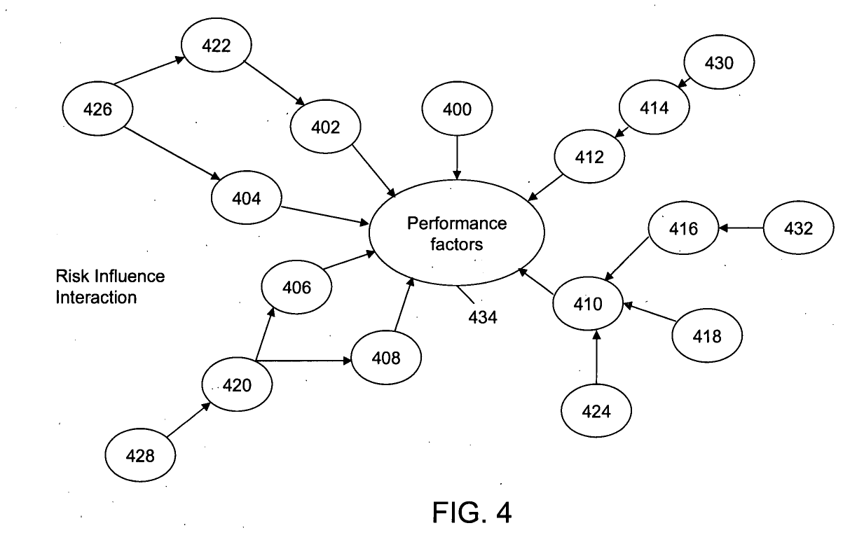

FIG. 4 illustrates a chart depicting an exemplary way of representing the interactions between the risk events. This chart can-also be termed as the influence interaction diagram since it depicts influence interactions between risk events.

Referring to FIG. 4, a risk event 400 can be defined as a standalone risk event that directly impacts at least one performance measure 434 that is being considered by the simulation process. Thus, risk event 400 is known as ‘direct risk’. For instance, natural disaster is a risk event that is independent of any other event and can have a direct impact on performance measure 434.

On the other hand, each of risk event 402, risk event 404, risk event 406, risk event 408, risk event 410, and risk event 412 also directly impact performance measure 434 of the supply chain. However, the probability of occurrence or overall impact of these risk events depends on the outcome of one or more predecessor risk events. Thus, risk event 402, risk event 404, risk event 406, risk event 408, risk event 410, and risk event 412 are called ‘direct dependent risks’. An example of a direct dependent risk is the risk related to rebuilding a particular site within a supply chain. This risk may directly affect the lead-time of the supply chain. It is to be noted that the risk of rebuilding may depend on damages and losses that are incurred, for example, damages caused by floods during the monsoon season.

Furthermore, each of risk event 414, risk event 416, risk event 420, and risk event 422 do not directly impact performance measure 434. Moreover, the probability of occurrence of these risks depends upon the outcome of one or more predecessor risk events. Risk events that influence the impact of a direct risk event are the predecessor risk events. Similarly, the risk events that are dependent on one or more predecessor risk events are referred to as successor risk events. Thus, risk event 414, risk event 416, risk event 420, and risk event 422 are called ‘indirect dependent risks’. Referring to the same example as stated previously, the risk of incurring damages or losses affect performance measure 434 indirectly. At the same time, the risk of incurring damages or losses may be dependent on a predecessor risk event, for example, floods during the monsoon season.

Moreover, each of risk event 418, risk event 424, risk event 426, risk event 428, risk event 430, and risk event 432 do not directly impact performance measure 434. Moreover, these risk events change the probability of occurrence of successor risk events, but they do not have a predecessor risk event. Thus, risk event 418, risk event 424, risk event 426, risk event 428, risk event 430, and risk event 432 are simply called ‘indirect risks’. Considering the example stated above, the risk of flooding during the monsoon season can be called an indirect risk.

Additionally, it can be seen from FIG. 4 that the occurrence of risk event 416, risk event 418, and risk event 424 is independent of each other. Moreover, these risk events do not directly impact performance measure 434. In addition, different combinations of these risk events drive different successor probabilities and impacts differently. Thus, risk event 416, risk event 418, and risk event 424 are called ‘indirect interdependent risks’. For example, a risk due to delay at origin may directly impact the lead-time of the supply chain. Origin delay, in turn, can be influenced by the risk involved in, for example, trucking of raw material at the origin or by the risk due to delay in export clearance time. This makes the risk involved in trucking at the origin and the risk due to export clearance time, indirect risks. Different combinations of the direct risk of origin delay and the two indirect risks that influence the risk of origin delay, impact the lead-time differently. As a result, the risk involved in trucking at the origin and the risk due to delay in export clearance time are called indirect interdependent risks.

Also, risk event 412, risk event 414, and risk event 430 together form a ‘risk chain of events’. In other words, all interdependent and related risk events that contribute to or directly impact the supply chain performance measure 434 are grouped together to form various ‘risk chain of events’.

Referring again to FIG. 2, predecessor risk events for the risk events that were identified at step 204 and for which their interactions were determined at step 206, are retrieved at step 208. The predecessor risk events are all the types of indirect risk events explained in FIG. 4. They are called predecessor risk events because they precede the risk events that influence the performance measures. The predecessor risk events are retrieved by obtaining information about them in the form of risk event tables, which carry various details about the risk events.

At step 210, all the risk events that were identified at step 204, and their predecessors, are quantified. The quantification helps in establishing the impact that a risk event can have on a performance measure. Quantification can be of two types: basic or advanced. Basic quantification involves determining the impact of a direct risk event irrespective of whether the risk event is a dependent risk or not. On the other hand, advanced quantification also incorporates the indirect risk events that influence a dependent direct risk event. In an embodiment of the invention, the advanced quantification is used for quantifying the risk events. In this case, quantification is done in light of the risk interactions that were determined at step 206. Simulation engine 106 uses the relevant information regarding the risk event and determines whether the impact of the risk event is deterministic or not. In case the impact is non-deterministic, simulation engine 106 uses an appropriate distribution curve to characterize a range of possible impacts. Exemplary sets of distribution curves that are used in an embodiment of the invention are described hereinafter. It is to be understood that those possessing ordinary skill in the art will recognize that a risk distribution parameter may be assigned by a user or retrieved from a suitable data base.

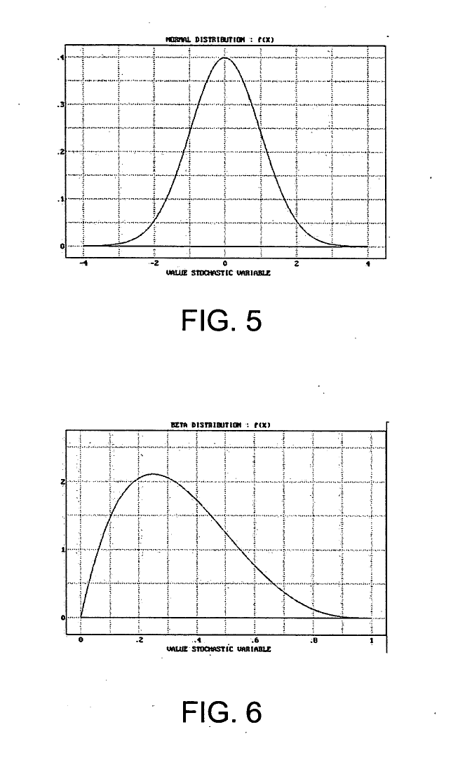

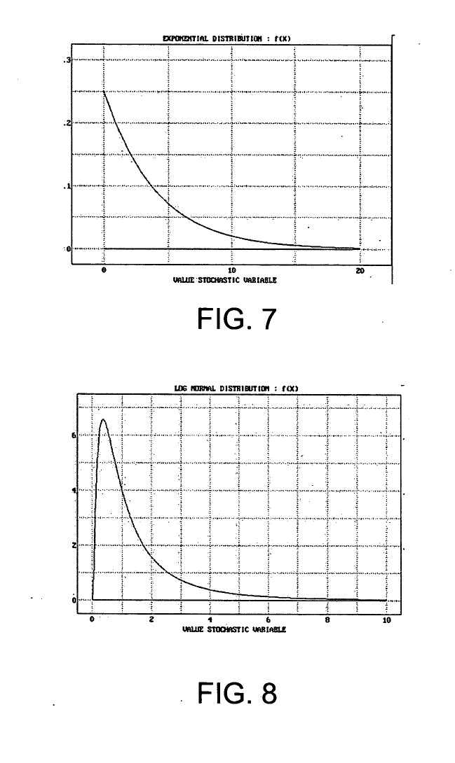

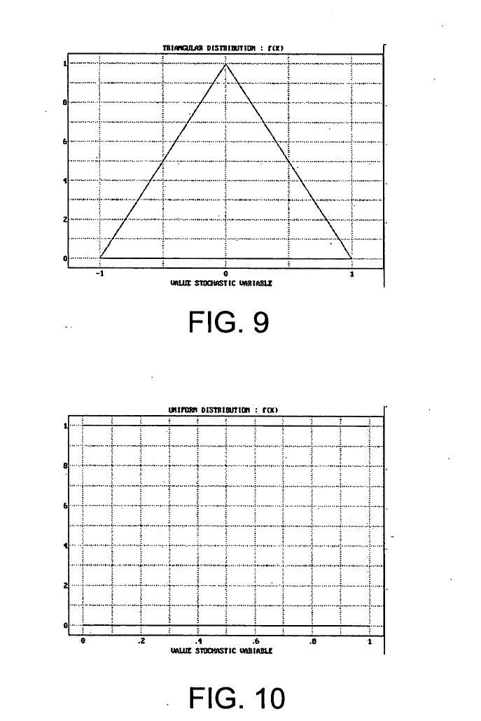

FIG. 5 illustrates a normal distribution curve that can be used for advanced quantification. FIG. 6 illustrates another distribution curve called beta distribution curve that can be used for advanced quantification. FIG. 7 illustrates another distribution curve called exponential distribution curve. FIG. 8 illustrates yet another distribution curve, called lognormal distribution curve. FIG. 9 illustrates another distribution curve, called triangular distribution curve. FIG. 10 illustrates another distribution curve called uniform distribution curve.

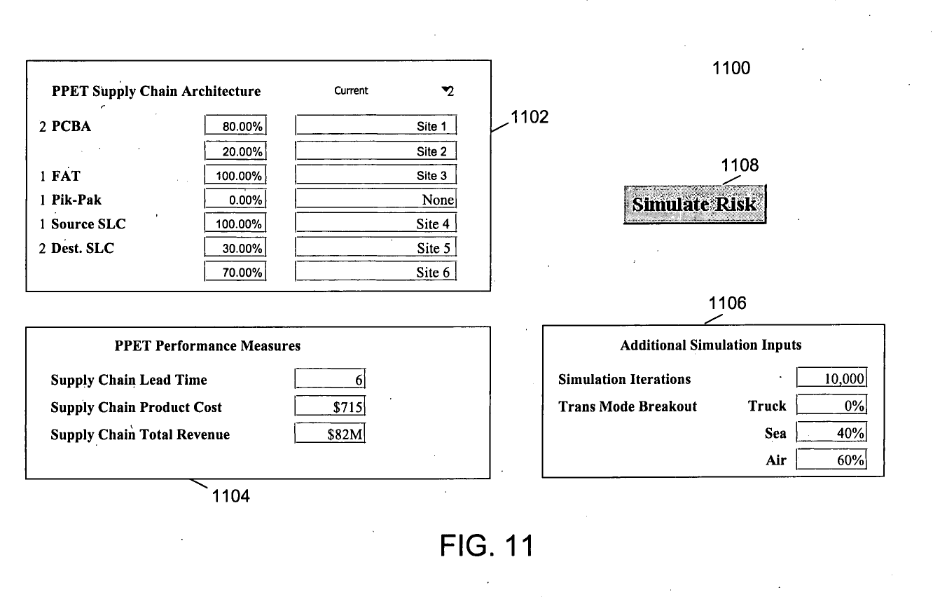

Referring again to FIG. 2, following the quantification of risk events at step 210, simulation is performed at step 212. An interface can be provided to the user to facilitate collection and co-relation of information required for simulation. FIG. 11 illustrates an exemplary Graphical User Interface (GUI) 1100 for inputting information required for simulating the supply chain risks. Module 1102 is for providing information relating to the supply chain architecture. Module 1104 is for providing information relating to the performance measure of the supply chain. The figure illustrates three performance measures that are commonly considered for supply chain risk simulation. These performance measures are lead-time, product cost, and total revenue. Module 1106 is used for defining simulation criteria. With the help of module 1106, the user can classify additional simulation inputs such as simulation iterations, to simulate the supply chain risks. Once the user validates and enters all the information illustrated in the GUI of FIG. 11, a button 1108 is pressed for simulating the risks. In an embodiment of the invention, Monte Carlo simulation is used to simulate multiple scenarios of a defined supply chain system. This is done by repeatedly generating values from the probability distributions for the variables and using them to compute the impact on each performance measure. Monte Carlo simulation is performed by simulation engine 106. For each scenario, the impacts on each performance measure are computed. Once the Monte Carlo simulation is finished, the results are aggregated and the process proceeds to step 214.

At step 214, the aggregated simulation results are interpreted to determine the risk within the supply chain system. The interpretation can be provided in the form of visual representations. In an embodiment, the invention provides risk-adjusted graphs that indicate the amount of variance introduced by risk events in the supply chain. In another embodiment, the visual representation comprises risk maps in addition to the risk-adjusted graphs. The risk maps highlight the main risk drivers, their relative probability of occurrence, and the expected value of impact.

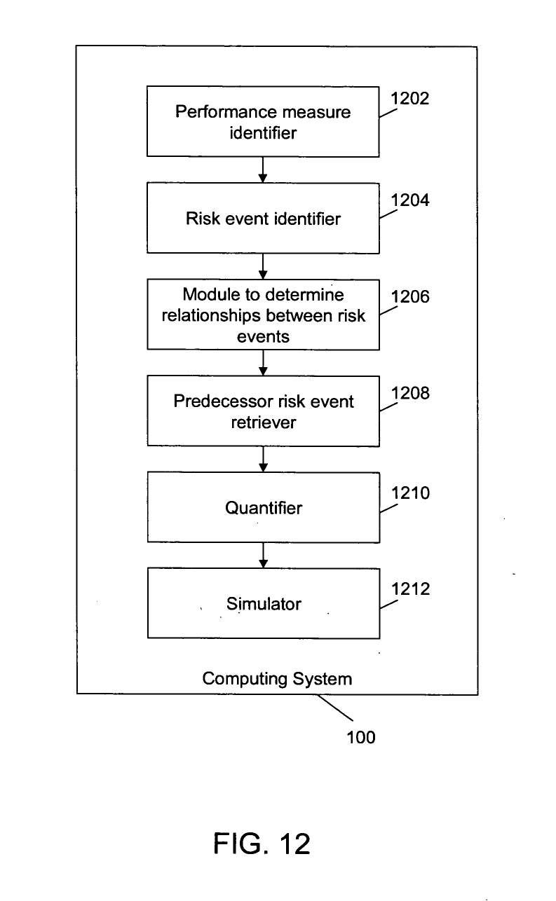

FIG. 12 is a block diagram illustrating an exemplary system to implement a method in accordance with an embodiment of the invention. According to the figure, various system modules are configured inside computing system 100. A performance measure identifier 1202 helps to identify and define performance measures of a specific supply chain system. As mentioned earlier, performance measures could be time-related or cost-related. A risk event identifier 1204 further helps in identifying the risk events associated with the hierarchy of the supply chain system that impact the identified performance measures. A module 1206 provides the user with means to determine the interactions between the risk events. The interactions aid the user to define risk influence interactions. An exemplary representation of influence interactions is illustrated in FIG. 4. A predecessor risk event retriever 1208 retrieves the predecessor risk events for including them in the simulation analysis. Further, a quantifier 1210 quantifies the risk events. Quantifier 1210 differentiates between the deterministic and non-deterministic risk events and computes the impacts or range of impacts of the risk events accordingly. The simulation of supply chain risk models is performed by a simulator 1212. Simulator 1212 is used to compute and display results of simulation to the user.

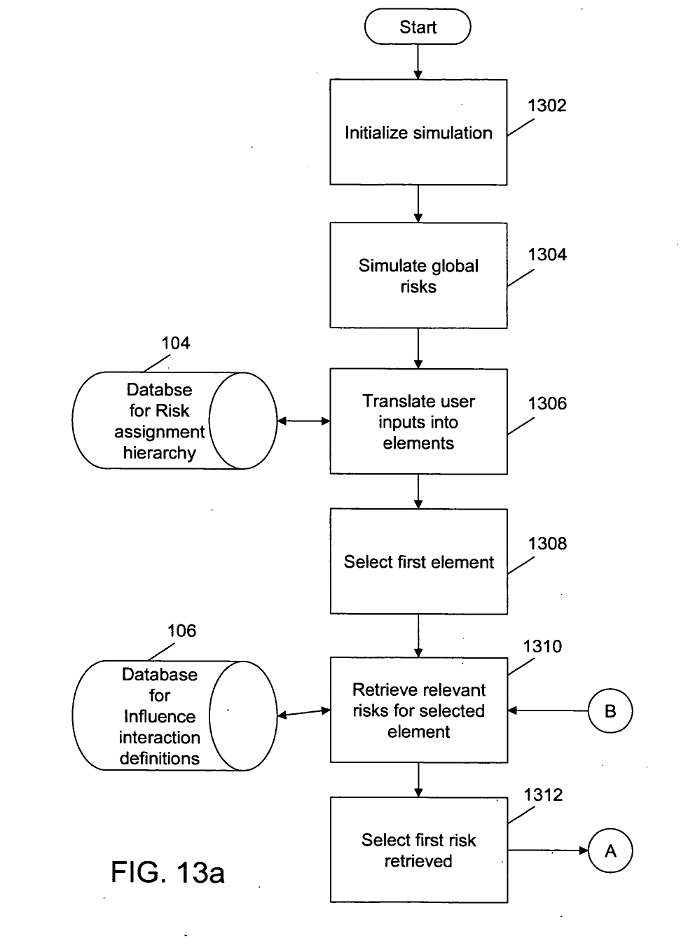

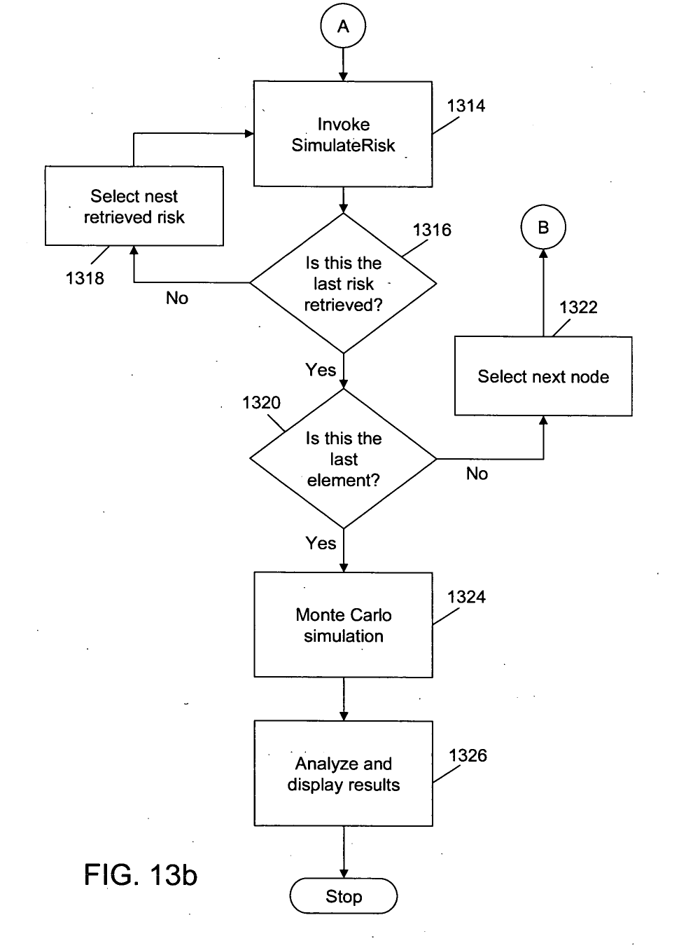

An embodiment of the present invention is illustrated in FIG. 13 by way of illustration only and not by way of any limitation. The example of FIG. 13 is not to be construed to unduly limit the scope of the invention. FIG. 13 is a flow chart illustrating an exemplary flow of processes, in accordance with an embodiment of the invention.

The process of simulation, in accordance with the present invention, is initialized at step 1302. On its initialization, global risks are simulated at step 1304. Global risks comprise all the risk events that can have an impact at all the levels of the supply chain system hierarchy that is being considered. At step 1306, user inputs are translated into elements of the supply chain system. As mentioned earlier, the elements of the supply chain system are the constituents of the physical levels of the supply chain system. The user inputs can be provided through a graphical user interface such as the one shown in FIG. 3. This interface facilitates the user to update, add, or delete supply chain information. With the help of this interface, it is also possible for the user to provide only certain portions of the supply chain system. Once the inputs are provided, computing system 100 performs an analysis to determine the supply chain hierarchy.

The user inputs are translated into elements at step 1306 by coordinating with database 102 of risk assignment hierarchy. Database 102 provides identity tags for various elements according to the supply chain system hierarchy. A new identity tag is assigned to an element that is introduced by the user for the first time. For known elements, the information stored in database 102 is utilized. For instance, new identity tags for new elements corresponding to region, country, node, site, or function within the supply chain are assigned and stored. Each identity tag points to a table that contains information relating to the details for a specific element. Following the assembly of identity tags, duplicate identity tags are eliminated so that the possibility of repeated simulation of risk events is removed, resulting in an efficient utilization of computing resources and greater speeds.

At step 1308, one of the elements provided by the user is selected for further processing. Relevant risk events for the element selected at step 1308 are retrieved at step 1310. The relevant risks are obtained with the help of database 104 containing risk influence interaction definitions. Database 104 allows all the risk events that can impact the supply chain system to be identified.

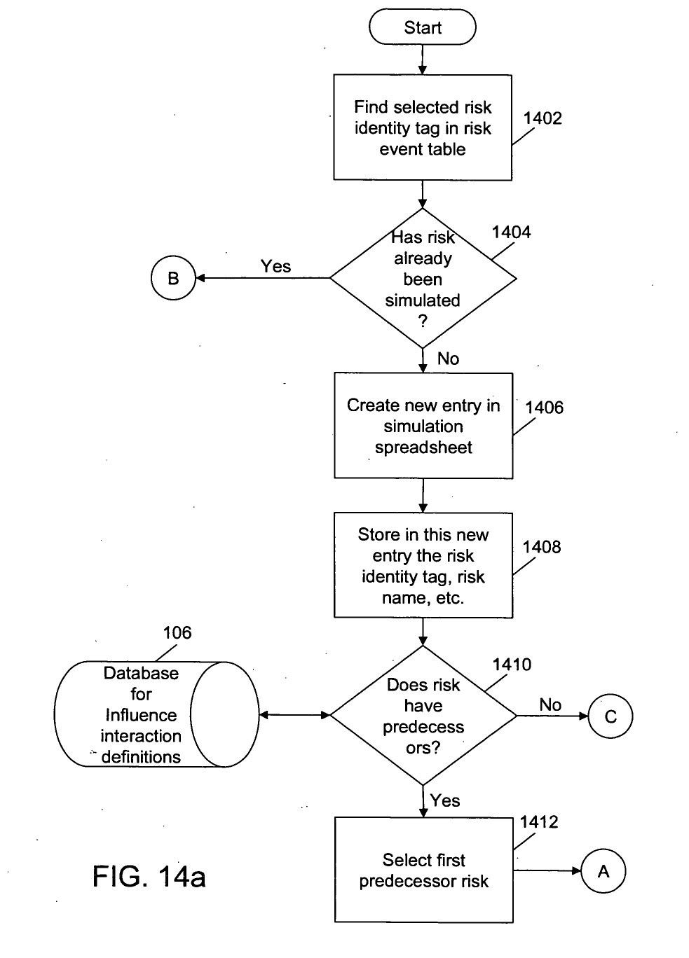

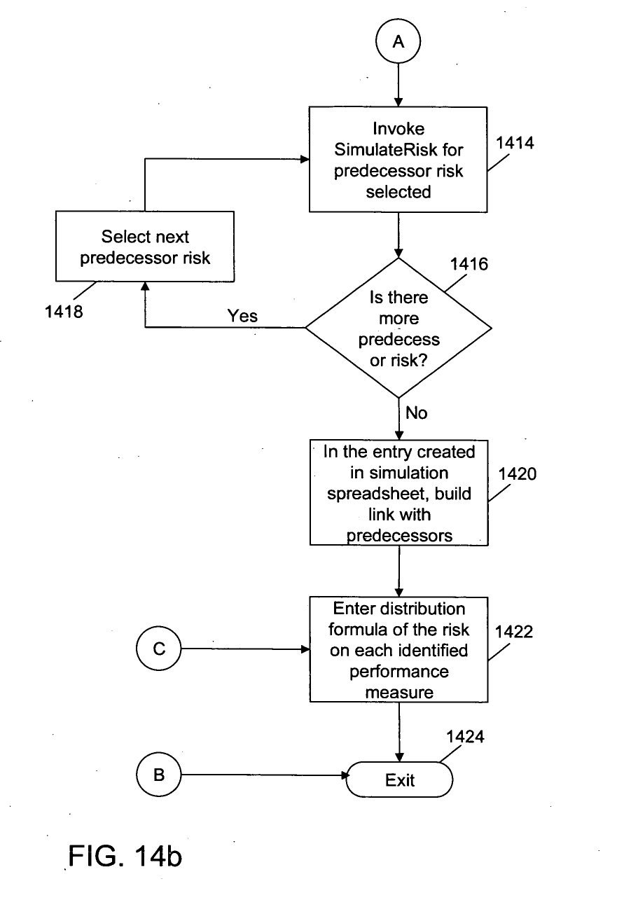

At step 1312, the risk event that is retrieved at step 1310 is selected for simulation. At step 1314, a function ‘SimulateRisk’ is invoked. SimuateRisk simulates the selected risk event. The process of simulation performed by SimulateRisk is subsequently explained in conjunction with the flow chart in FIG. 14.

Following the selection of the risk event, it is determined at step 1316 whether the risk event selected at step 1312 was the last of the relevant risk events retrieved at step 1310. In case the selected risk event was not the last, then the method proceeds to step 1318. At step 1318, the next among the risk events that were retrieved at step 1310 is selected. Steps 1314 to 1318 are performed repeatedly until all the retrieved risk events have been simulated. Once all the retrieved risk events are simulated, the system according to an embodiment of the invention proceeds to step 1320. At step 1320, the system checks whether the element for which the relevant risk events were simulated, is the last among all the elements that were provided by the user at step 1306. If it is determined that the element is not the last then the next element, which was provided by the user at step 1306, is selected at step 1322. Steps 1310 to 1322 are performed repeatedly until all the elements are processed. Subsequently, at step 1324, Monte Carlo simulation is performed according to an embodiment of the invention. Following the Monte Carlo simulation, the analysis and display of the simulation outputs is performed at step 1326. The simulation outputs can be in the form of risk maps or in other forms, such as risk-adjusted graphs. Thus, the simulation results can be analyzed by assembling distribution curves, risk maps, and overall results. Completion of step 1326 marks the completion of the risk simulation process in accordance to the invention.

FIG. 14 illustrates the subroutine for the function SimulateRisk. This function is mainly responsible for quantification of risk events. Quantification has already been explained earlier in conjunction with FIG. 2. The system, according to an embodiment of the invention, enters the subroutine described in FIG. 14 when the function SimulateRisk is called at step 1314 in the flow chart of FIG. 13. At step 1402, the function searches for an entry in the risk event table that corresponds to the risk event that was selected at step 1312 of the flow chart in FIG. 13. At step 1404, it is determined whether the selected risk event has already been simulated. The risk table provides information relating to simulation of the risk event. This information avoids repetitive simulation of a specific risk event. If the selected risk event is determined to have been simulated at least once earlier, then the function exits the subroutine at step 1424 to return to the flow of processes as described in FIG. 13. However, in case it is determined at step 1404 that the selected risk event has not been simulated before, the function proceeds to step 1406. At step 1406, a new entry for the selected risk event is created in a simulation spreadsheet. In an embodiment of the invention, the simulation spreadsheet can be a Microsoft® Excel based spreadsheet that stores information about each risk event along with its name, identity tag, and other details. At step 1408, the new entry that is created is filled with information relating to the risk name, the risk identity tag, and the like.

At step 1410, the function determines whether the selected risk event has any predecessor risk events. The presence of predecessor risk events is determined with the help of database 104 of risk influence interaction definitions. In case the selected risk event does not have any predecessor risk event, the function jumps to step 1422. At step 1422, the distribution formula applicable to the selected risk event is entered. The distribution curves for such distribution formulas have been illustrated in FIGS. 5 to 10. However, if it is determined at step 1410 that predecessor risk events for the selected risk events do exist, then the first of the predecessor risk events is selected. This is done at step 1412. The first predecessor risk event can be among one of the risk events that immediately precede the selected risk event.

At step 1414, the function SimulateRisk is called again to simulate the selected predecessor risk event. In this way, any risk events that precede the predecessor risk event are also simulated. At step 1416, it is determined whether any more predecessor risk events to the selected risk events exist. If they do, the next predecessor risk event is selected at step 1418. Following this, steps 1414 to 1418 are repeatedly performed until the last predecessor risk event has been simulated. Once the last predecessor risk event has been simulated, the function proceeds to step 1420. At step 1420, the entry in the simulation spreadsheet that corresponds to the selected risk event is updated with links to predecessor risk events. These links point to the entries in the simulation spreadsheet that correspond to the predecessor risk events.

Following the updating of the simulation spreadsheet, the distribution formula applicable to the selected risk event is entered at step 1422. At step 1424, the function exits to return to the process of FIG. 13.

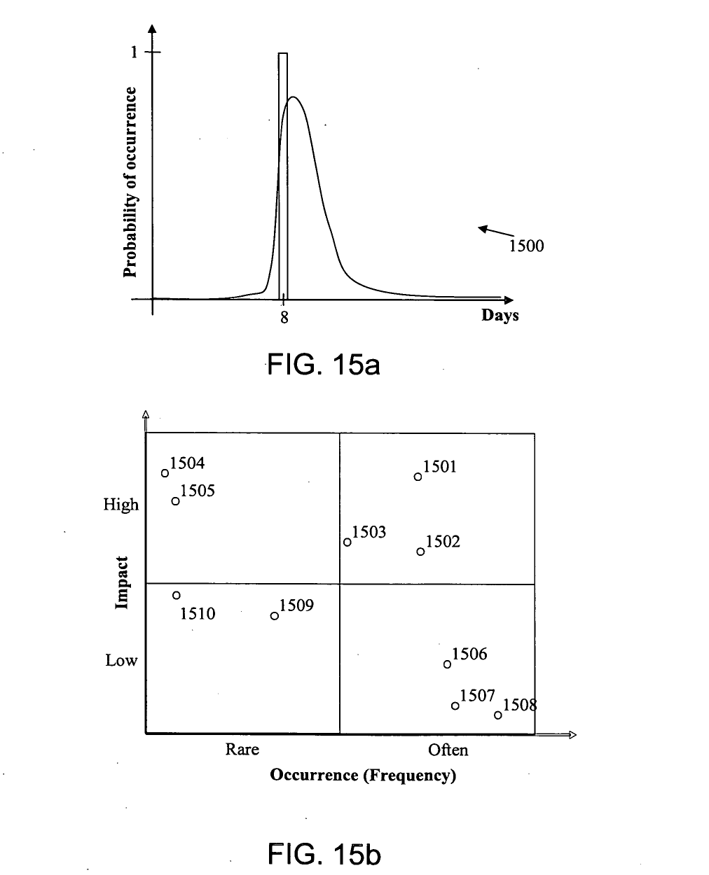

FIG. 15 illustrates exemplary visual representations of the simulation outputs that can be provided in an exemplary embodiment of the invention. FIG. 15a shows by way of example only a risk-adjusted graph 1500 with ‘lead-time’ as a performance measure. The graph in FIG. 15a represents probability of occurrence versus the amount of variance in lead-time introduced by risk events in the supply chain. FIG. 15b shows by way of example only a lead-time risk map. The risk map highlights the main risk driver, their relative probability of occurrence, and expected value of impact. The points inside the lead-time risk map represent the various types of risk events. For instance, a point 1508 can correspond to risks arising out of custom issues. The location of point 1508 in the risk map signifies that the probability of occurrence of custom-related issues is the highest among all the other risk events that affect the lead-time of the supply chain. At the same time, it can be seen from the figure that the impact of risks arising due to custom related issues is minimal as compared to all the other risk events. Similarly, the occurrence and impact of various risk events, and their relative effect can be analyzed with the help of the risk map. In an embodiment, the points within the lead-time risk map can represent the following risk events: a point 1501 for representing critical component shortages, a point 1502 for forecast variability, a point 1503 for CM machinery downtime, a point 1504 for supplier part quality, a point 1505 for natural disaster, a point 1506 for regional political events, a point 1507 for transportation delays, a point 1509 for process changes that can take place within the supply chain, and a point 1510 for representing engineering change orders.

### CONCLUSION

The present invention provides a method and system for identifying, quantifying, and analyzing risks within a supply chain infrastructure. The process, in accordance with the invention, combines risk event data, risk interaction definitions, a risk assignment hierarchy and a simulation engine to dynamically model the expected impact of risk to pre-defined performance measures within the system.

The present invention provides a flexible method for simulation and analysis of risks involved with a defined supply chain system in real time. The system according to the invention delivers a quantified measure of risk within a supply chain infrastructure as well as identifies the most salient risks that need to be targeted for mitigation. Thus, the concerned executive management for the supply chain can make informed decisions regarding risk management and mitigation. The structures and formats used in the method of the invention facilitate ease of sharing risk-related information.

Although the invention has been discussed with respect to specific embodiments thereof, these embodiments are merely illustrative, and not restrictive, of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of the embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

In the description herein for embodiments of the present invention, a portion of the disclosure recited in the specification contains material, which is subject to copyright protection. Computer program source code, object code, instructions, text, or other functional information that is executable by a machine may be included in an appendix, tables, figures, or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, smart card, set-top box, or any of the like. A ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio, or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly/indirectly coupled input/output (I/O) device, the computer would have suitable instructions for allowing a user to input or output (e.g., present) program code and/or data information, respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system, or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

Reference throughout this specification to ‘one embodiment’, ‘an embodiment’, or ‘a specific embodiment’ means that a particular feature, structure, or characteristic described in connection with the embodiment is included in at least one embodiment of the present invention and not necessarily in all embodiments. Thus, respective appearances of the phrases ‘in one embodiment’, ‘in an embodiment’, or ‘in a specific embodiment’ in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as a part of the spirit and scope of the present invention.

Further, at least some of the components of an embodiment of the invention may be implemented by using a programmed general purpose digital computer, by using application-specific integrated circuits, programmable logic devices, or field-programmable gate arrays, or by using a network of interconnected components and circuits. Connections may be wired, wireless, by modem, and the like.

It will also be appreciated that one or more of the elements depicted in the drawings/figures can be implemented in a more separated or integrated manner, or even removed or rendered as inoperable in certain cases, as is useful in accordance with a particular application. It is also within the spirit and scope of the present invention to implement a program or code that can be stored in a machine-readable medium to allow a computer to perform any of the methods described above.

Additionally, any signal arrows in the drawings/figures should be considered only as exemplary, and not limiting, unless otherwise specifically noted. Furthermore, the term ‘or’ as used herein is generally intended to mean ‘and/or’, unless otherwise indicated. Combinations of components or steps will also be considered as being noted, where terminology is foreseen as rendering the ability to separate or combine is unclear.

As used in the description herein and throughout the claims that follow, ‘a’, ‘an’, and ‘the’ include plural references, unless the context clearly dictates otherwise. Also, as used in the description herein and throughout the claims that follow, the meaning of ‘in’ includes ‘in’ and ‘on’, unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for determining risk within a defined system comprising:
identifying at least one performance measure for identifying and quantifying risk events within the defined system;
identifying the risk events that impact the performance measures based on a hierarchy of the defined system;
determining at least one relationship between the identified risk events and at least one performance measure;
retrieving at least one risk event related to the performance measure associated with the hierarchy of the defined system;
quantifying the risk events assigned to the hierarchy of the defined system;
conducting a risk simulation from the quantified risk events assigned to the hierarchy of the defined system to produce at least one simulation output; and
interpreting the simulation output for determining the risk within the defined system.

2. The method of claim 1 wherein the determining risk within a defined system comprises determining risk within a supply chain system.

3. The method of claim 1 wherein the identifying performance measures comprises identifying lead time as a performance measure.

4. The method of claim 1 wherein the identifying performance measures comprises identifying product cost as a performance measure.

5. The method of claim 1 wherein the identifying performance measures comprises identifying revenue as a performance measure.

6. The method of claim 1 wherein the assigning the risk events comprises assigning at least one risk event to a region.

7. The method of claim 1 wherein the assigning the risk events comprises assigning at least one risk event to a country.

8. The method of claim 1 wherein the assigning the risk events comprises assigning at least one risk event to a site.

9. The method of claim 1 wherein the assigning the risk events comprises assigning at least one risk event to a specific contract manufacturer function.

10. The method of claim 1 wherein the assigning the risk events comprises assigning at least one risk event to a node, the node being a unique combination of site and function.

11. The method of claim 1 wherein the conducting the risk simulation comprises conducting a Monte Carlo simulation.

12. A system for determining risk within a defined system comprising:
a computer;
a machine-readable medium including instructions executable by the computer comprising:
one or more instructions for identifying at least one performance measure for identifying and quantifying risk events within the defined system;
one or more instructions for identifying risk events that impact the performance measures based on a hierarchy of the defined system;
one or more instructions for determining at least one relationship between the identified risk events and at least one performance measure;
one or more instructions for retrieving at least one risk event related to the performance measure associated with the hierarchy of the defined system;
one or more instructions for quantifying the risk events assigned to the hierarchy of the defined system; and
one or more instructions for conducting a risk simulation from the quantified risk events assigned to the hierarchy of the defined system to produce at least one simulation output for interpretation to determine risk within the defined system.

13. A machine-readable medium including instructions executable by a computer comprising:
one or more instructions for identifying at least one performance measure for identifying and quantifying risk events within the defined system;
one or more instructions for identifying risk events that impact the performance measures based on a hierarchy of the defined system;
one or more instructions for determining at least one relationship between the identified risk events and at least one performance measure;
one or more instructions for retrieving at least one risk event related to the performance measure associated with the hierarchy of the defined system;
one or more instructions for quantifying the risk events assigned to the hierarchy of the defined system; and
one or more instructions for conducting a risk simulation from the quantified risk events assigned to the hierarchy of the defined system to produce at least one simulation output for interpretation to determine risk within the defined system.

14. A system for determining risk within a defined system comprising:
performance measure identifier for identifying at least one performance measure for identifying and quantifying risk events within the defined system;
risk event identifier for identifying risk events that impact the performance measures based on a hierarchy of the defined system;
means for determining at least one relationship between the identified risk events and at least one performance measure;
retriever for retrieving at least one risk event related to the performance measure associated with the hierarchy of the defined system; and
simulator for conducting a risk simulation from the quantified risk events assigned to the hierarchy of the defined system to produce at least one simulation output for interpretation to determine risk within the defined system.

15. The system of claim 14 wherein the system further comprises a database for storing risk events at corresponding physical levels within the hierarchy of the defined system.

16. The system of claim 14 wherein the system further comprises a database for storing relationships between the related risk events.

17. A system for determining risk within a defined system comprising:
means for conducting a risk simulation from the quantified risk events assigned to a hierarchy of a defined system to produce at least one simulation output for interpretation to determine risk within the defined system.

18. The system of claim 17 additionally comprising:
means for receiving identified performance measures for identifying and quantifying risk events within the defined system;
means for receiving identified risk events that impact the performance measures;
means for receiving at least one determined relationship among the risk events;
means for receiving risk events assigned to an hierarchy of the defined system; and
means for retrieving at least one relevant risk event associated with the hierarchy.
